(19) United States
(12) Patent Application Publication
(10) Pub. No.: US 2023/0326436 A1
(43) Pub. Date: Oct. 12, 2023

(54) Automated Music Composition and Generation System and Method

(71) Applicant: ECOLE POLYTECHNIQUE FEDERALE DE LAUSANNE (EPFL), Lausanne (CH)

(72) Inventor: Florian Colombo, Lausanne (CH)

(21) Appl. No.: 17/704,096

(22) Filed: Mar. 25, 2022

(51) Int. Cl. G10H 1/00

(52) U.S. Cl. CPC G10H 1/0025; G10H 2210/111; G10H 2250/311

(57) ABSTRACT

An automated music composition and generation system for automatically harmonizing digital pieces of music using an automated music composition and generation engine for multi-voice music harmonization, including a system-user interface configured to input user parameters comprising at least an instrument designation, a composer style designation, an empty or partial input musical score to be automatically completed, whereby the instrument designation and the composer designation are any one of a predetermined list of instrument designations and composer designations, an automated music composition and generation engine configured to implement a generation strategy that produces playable and well-structured multi-voice music scores, operationally connected to the system-user interface, and a neural network module configured to implement a rhythm recurrent artificial neural network model, a melody recurrent artificial neural network model and a harmony feedforward neural network model that have been trained for combinations of the instrument designations and composer designations of the predetermined list.

### TECHNICAL FIELD

The invention relates to an automated music composition and generation system, and also relates to artificial neural networks for a method of automatically composing and generating music.

### BACKGROUND

Artificial music generation is one of the most challenging tasks in computational musicology. U.S. Pat. No. 9,721,551 describes an automated music composition and generation system and method, this reference herewith incorporated by reference in its entirety, and architectures that allow anyone, without possessing any knowledge of music theory or practice, or expertise in music or other creative endeavors, to instantly create unique and professional-quality music, synchronized to any kind of media content, including, video, photography, slideshows, and any pre-existing audio format, as well as any object, entity, and/or event, wherein the system user only requires knowledge of one’s own emotions and/or artistic concepts which are to be expressed in a piece of music that will ultimately be composed by the automated composition and generation system. While music composition with artificial neural networks is a growing field, there is no broadly adopted standard of how to represent (input encoding) and generate music with neural network models.

Therefore, in light of the deficiencies of the state of the art for the automatic and computer-generated generation of music, substantially improved computer systems and methods are desired, for example to be able to play the generated music on real instruments, musicians require well-structured music scores. Therefore, according to at least some aspects of the present invention, it is possible to improve upon the state of the art by processing the musical contents of digital music scores to analyze them and generate new playable scores.

### SUMMARY

According to one aspect of the present invention, an automated music composition and generation system for automatically harmonizing digital pieces of music using an automated music composition and generation engine for multi-voice music harmonization. Preferably, the system includes a system-user interface configured to input user parameters comprising at least an instrument designation, a composer style designation, an empty or partial input musical score, whereby the instrument designation and the composer designation are any one of a predetermined list of instrument designations and composer designations, an automated music composition and generation engine configured to implement a generation strategy, operationally connected to the system-user interface; and a neural network module configured to implement a rhythm recurrent artificial neural network model, a melody recurrent artificial neural network model and a harmony feedforward neural network model that have been trained for combinations of the instrument designations and composer designations of the predetermined list.

Moreover, preferably, the automated music composition and generation engine further being operationally connected to the neural network module and configured to generate a newly composed musical score by operating the neural network module with the input user parameters, the newly composed musical score comprising a musical score for at least one instrument designation, and preferably the system-user interface is further configured to receive the newly composed musical score from the automated music composition and generation engine, and output the newly composed musical score by means of the system-user interface.

According to another aspect of the present invention, a method for automated music composition and generation for automatically harmonizing digital pieces of music using an automated music composition and generation engine for multi-voice music harmonization is provided.

According to still another aspect of the present invention, a method for preprocessing of symbolic music is provided. Preferably, the method includes the step of comprising encoding rhythms, melody, and harmony of a least a training musical score comprising a plurality of voices, into five (5) features shared across all of the plurality of voices plus five (5) voice-specific features, the voice-specific features comprising for each voice not only the on-sets, durations, and pitches of notes within every beat, but also intervals within a voice and intervals to other voices, and relying on meta-signals shared across voices such as the harmonic progression, beat position within the bar, and metric.

According to yet another aspect of the present invention, a non-transitory computer readable medium is provided, the computer-readable medium having computer code recorded thereon, the computer code configured to perform a method for automated music composition and generation for automatically harmonizing digital pieces of music using an automated music composition and generation engine for multi-voice music harmonization, or a method for preprocessing of symbolic music, when executed on a digital data processor.

According to another aspect to the present invention, the herein presented system and method aims at providing a solution that instead of emotions and artistic concepts intended to be expressed, relies on elements of music theory to compose and provide at least one candidate new voice to complement a user-specified partial or complete score.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 includes an overview illustration of an encoding and generating system according to one aspect of the present invention, for example but not limited to the use of the BeethovANN system which is trained to generate an alternative voice for each of the four voices in a Beethoven string quartet. Here, we illustrate BeethovANN generating an alternative voice for the cello. To do so, it processes the formalized musical content of other voices;

FIG. 2 includes an illustration of an example rhythm architecture;

FIG. 3 includes an illustration of an example melody model architecture;

FIG. 4 includes an illustration of an example harmony model architecture;

FIG. 5 includes an illustration of an example generation strategy;

FIG. 6 illustrates an example of features during one musical phrase;

FIG. 7 illustrates an example of key embeddings;

FIG. 8 illustrates effects of chord conditioning;

FIG. 9 illustrates an example of distribution of chords;

FIG. 10 illustrates an example of repetition of rhythm motifs;

FIG. 11 shows a table that includes a list of voice specific features used in annotated Beethoven string quartets;

FIG. 12 show a table that includes correspondences between metric and number of beats and their length;

FIG. 13 shows a table that includes values pertaining to performance of network models;

FIG. 14 includes an exemplary block diagram schematically illustrating parts of an automated music composition and generation system for automatically harmonizing digital pieces of music according to an example embodiment of the invention; and

FIG. 15 includes a flowchart of an example embodiment of the invention in which it is used to automatically generate scores for a symphonic orchestra in a single click.

Herein, identical reference numerals are used, where possible, to designate identical elements that are common to the figures. Also, the images are simplified for illustration purposes and may not be depicted to scale.

### DETAILED DESCRIPTION OF PREFERRED EMBODIMENTS

The present invention will be better understood through the description of example embodiments, including that of an automated music composition and generation system for automatically harmonizing digital pieces of music using an automated music composition and generation engine for multi-voice music harmonization that comprises a deep learning algorithm.

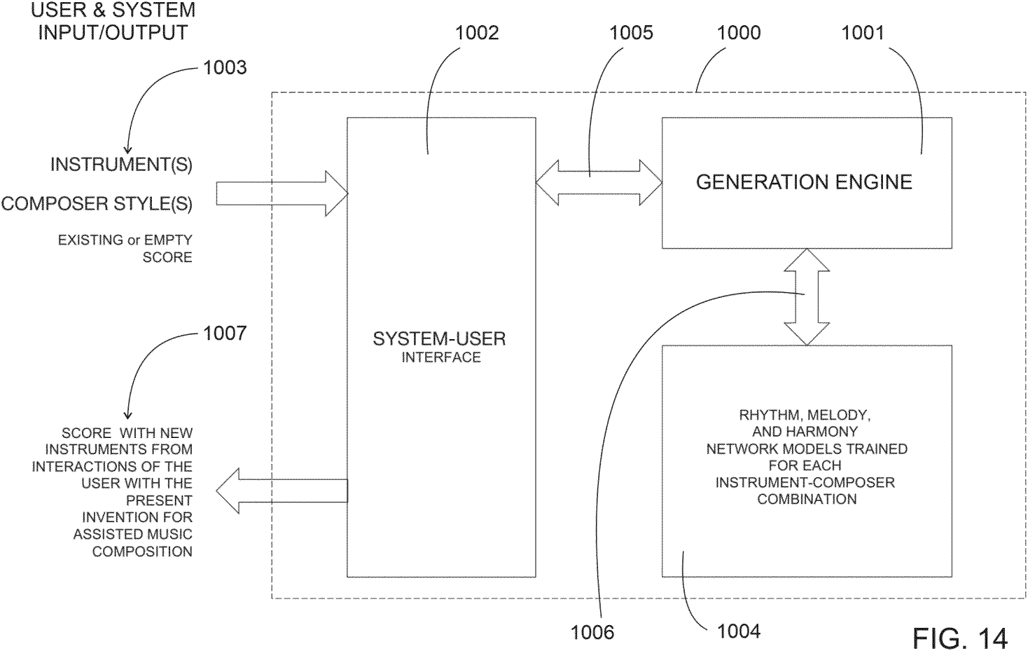

FIG. 14 shows a block diagram schematically illustrating parts of such an automated music composition and generation system 1000 for automatically harmonizing digital pieces of music. The automated music composition and generation system 1000 comprises an automated music composition and generation engine 1001 for multi-voice music harmonization. The system 1000 further comprises a system-user interface 1002 configured to input user parameters 1003 comprising at least an instrument designation, a composer style designation, and a musical score, whereby the instrument designation and the composer designation are any one of a predetermined list of instrument designations and composer designations, this list not illustrated in FIG. 14. The automated music composition and generation engine 1001 is configured to implement a generation strategy and is operationally connected 1005 to the system-user interface 1002. A neural network module 1004 is configured to implement a rhythm neural network model, a melody neural network model and a harmony neural network model that have been trained for combinations of the instrument designations and composer designations of the predetermined list. The automated music composition and generation engine 1001 is operationally connected 1006 to the neural network module 1004 and configured to generate a newly composed musical score 1007 by operating the neural network module 1004 with the input user parameters 1003, the newly composed musical score 1007 comprising a musical score for the at least one instrument designation. The system-user interface 1002 is further configured to receive the newly composed musical score 1007 from the automated music composition and generation engine 1001, and output the newly composed musical score 1007 on the interface.

In the present non-limiting example, BeethovANN™ in the engine, as a non-limiting and commercially available example of a generative algorithm for music score to learn a music composition, which is an example of a deep learning algorithm for multi-voice music harmonization designed to complement missing voices or augment existing scores with additional voices. Music scores are represented symbolically by a rich encoding scheme that includes rhythmic, melodic, as well as harmonic features. The formalized music signals are used to train recurrent artificial neural network models for rhythm and melody and a feedforward network for harmony. The network outputs are combined to generate candidate voices that reflect the rhythmic and melodic features of other voices in the same phrase. We show that the approach bridges artificial neural networks with elements of music theory such as the circle of fifths or motif repetition, demonstrated by automatically generated musical samples. In the present example, training is performed on the annotated Beethoven corpus of 16 string quartets, but the methodology may be transferred to other styles and corpora.

BeethovANN is a harmonization system, which is a deep learning algorithm trained with the digital scores of the annotated Beethoven string quartets. See for example Neuwirth, Markus, et al. “The Annotated Beethoven Corpus (ABC): A dataset of harmonic analyses of all Beethoven string quartets.” Frontiers in Digital Humanities, year 2018, Vol. 16. The methodology combines concepts from music theory with the learning capabilities of artificial neural networks. Whereas, we exemplified our method with the Beethoven string quartets, one aim of BeethovANN is to model how notes and rhythms from each voice of a set of music scores are selected. To do so, we employ artificial neural networks of rhythm, melody, and harmony, to learn to infer the score of every voice based on the musical contents of other voices. The probabilities computed by the trained network models are processed to generate new voices designed to exhibit similar repetitions of musical motifs and harmonic progression as the original Beethoven quartets. Provided with accurate harmonic labels, BeethovANN may generate at least one new voice that can be played in replacement, or in addition to the original music. Importantly, the new voices for the first and second violins, the viola, and the cello are specific to the instrument and are designed to fit the context defined by rhythmical and melodic motifs present in the other voices as well as the given harmonic progression. The methodology in the present invention relies on three important component.

A novel preprocessing scheme for symbolic music encodes rhythms, melody, and harmony into five (5) features shared across all voices plus five (5) voice-specific features. The latter include for each voice not only the on-sets, durations, and pitches of notes within every beat, but also intervals within a voice and intervals to other voices. As a result of this encoding scheme, the musical context and perspective of the second violin is differentfrom that of the first one. The preprocessing also relies on meta-signals shared across voices such as the harmonic progression, beat position within the bar, and metric.
Three separate artificial neural networks use the preprocessed input. Models of melody and rhythm, implemented as recurrent neural networks, predict sequences of notes and their timings, respectively. Furthermore, a feedforward neural network trained on preprocessed harmony-related features learns which notes are most likely to be played together.
The algorithm that generates the new voices uses the output of the rhythm and melody networks to select amongst candidate motifs for rhythm and melody the one that is most likely to appear within the given musical phrase. The model of harmony is then used to adapt selected notes so as to match the given harmonic progression.

Training of the artificial neural networks is performed with the annotated Beethoven corpus (Neuwirth et al., 2018), which contains about 28′000 labels of harmony (key, degree, and form) for all seventy (70) movements of sixteen string quartets written by the German composer Ludwig van Beethoven. Advantageously, this example models this rich dataset on the note level. The string quartets reflect Beethoven’s transition from the classical music period to the romantic one and exhibit complex polyphonic interactions within voices as well as rich underlying harmonic progressions. Altogether, the corpus of Beethoven string quartets is a challenging dataset, because of its intrinsic musical complexity and diversity. On the other hand, string quartets are a convenient data set for our task at hand since the music score is naturally structured into four different voices.

Generally speaking, Generative algorithms based on artificial neural networks are increasingly present in creative domains (Colton et al., 2012) such as painting (Mordvintsev et al., 2015; Gatys et al., 2016) and writing (Elkins and Chun, 2020). While music composition with artificial neural networks is a growing field, there is no broadly adopted standard of how to represent (input encoding) and generate music with neural network models (Briot et al., 2020). Even though the problems of input encoding (‘representation’) and choice of network architecture for generation are intertwined, we discuss them separately.

With respect to the encoding of music, and the input representation and pre-processing, music can be represented at different levels of abstraction. On the one hand, music as one-dimensional pressure waves is encoded in audio files (e.g., WAV and MP3). On the other hand, music can be described in symbolic representations where musical events are encoded with tokens. The choice of tokens and their description vary from text (ABC) to digital instruments (MIDI) and scores (MusicXML). Moreover, some custom pre-processing is typically applied to the original data to represent them as inputs to music generation models. Since BeethovANN works with preprocessed symbolic tokens we mostly discuss related work from that domain.

In the piano roll representation used, e.g., by the DeepBach (Hadjeres et al., 2017), the BachBot (Lianget al., 2017), and the Coconet (Huang et al., 2017) harmonization systems, note durations are encoded using finite and constant time slices. A slice length of half the shortest duration is the standard choice. Since note durations must be a multiple of the slice length, representations of, e.g., triplets is difficult.

MIDI tokens where note timings are encoded with a finite number of very small time steps, i.e., MIDI ticks (default is 48 ticks per quarter note) allow to encode arbitrary durations, including expressive deviations from the score notation. Using this representation and a large-scale transformer model (Vaswaniet al., 2017), MuseNet (Payne, 2019) generates four- minute MIDI files for up to 10 instruments. Audio- based systems (e.g., WaveNet (Oord et al., 2016)) directly model the sound pressure waves. Thereby, expressive durations and timbre are part of the input and output signals. However, plain MIDI or audio-based systems lack the ability to generate playable music scores (Thickstun et al., 2019).

Addressing this issue, the folk-RNN system (Sturmet al., 2016) processes ABC file tokens (where each noteis represented by pitch and duration) to produce scores with well-defined metrics and durations of notes. Similarly, the BachProp system (Colombo et al., 2019) suggests a method to retrieve a single ABC-like representation from MIDI files. As a result, scores from theBachProp and folk-RNN systems could be performed live. Closer to our representation, the pop music transformer (Huang and Yang, 2020) enriches MIDI files with chord and time grids. However, these systems generate polyphonic music without voice separation and are hence not applicable to our problem of generating playable scores with individual voices such as a string quartet. To improve the representation of inputs compared to the state-of-the art, BeethovANN takes advantage of the richness of the information contained in digital scores (MusicXML files) and extracts from these more than ten features that enable us to represent music tokens in a rich, yet compact format.

With respect to architectures for music generation, neural network approaches to music composition span decades, from early connectionist approaches (Todd, 1989; Mozer, 1994) to large-scale transformer networks (Huang et al., 2018). Networks of long short-term memory (LSTM) units (Hochreiter and Schmidhuber, 1997) were able to generate jazz melodies constrained on a specified harmonic progression (Eck and Schmidhuber, 2002). Since then, recurrent networks with gated activations (i.e., LSTM or gated recurrent unit (Cho et al., 2014)) have been widely used in music generation systems (Oore et al., 2020; Thickstun et al., 2019; Hadjeres et al., 2017; Liang et al., 2017; Sturm et al., 2016; Colombo et al., 2017, 2019; Johnson, 2017). Other popular architectures for music composition include generative adversarial networks (Mogren, 2016), variational auto-encoders (Fabius and Van Amersfoort, 2014), and convolutional networks (Huang et al., 2017; Oord et al., 2016; Lattner et al., 2016). However, the field of computational music composition extends beyond artificial neural networks. Other methods for music generation include rule-based approaches (Ebciogu, 1990), evolutionary algorithms (Biles et al., 1994), Markov models (Hiller Jr and Isaacson, 1957; Pachet, 2003), formal grammars (Cope, 1992; Chemillier, 2004; Quick and Hudak, 2013; Quick and Thomas, 2019), and self-similar or chaotic systems (Leach and Fitch, 1995). We refer the readers to (Fernández and Vico, 2013) and (Carnovalini and Rodà, 2020) for reviews on these methods.

BeethovANN is a system based on neural networks, but has three important differences to classical approaches. First, inspired by the StructureNet (Medeot et al., 2018) and BachProp (Colombo et al., 2019) systems, BeethovANN uses a divide-and-conquer strategy: we do not train a single neural network but one feed-forward harmony network plus, for each voice, two gated recurrent networks, one to predict the target voice rhythm and one to predict the melody given its rhythm. Second, while the standard method to generate new sequences from recurrent networks is to iteratively sample the network output probabilities either directly (Todd, 1989; Mozer, 1994; Eck and Schmid-Huber, 2002; Liang et al., 2017; Sturm et al., 2016; Colombo et al., 2019; Johnson, 2017), or via Gibbs sampling (Boulanger-Lewandowski et al., 2012; Hadjeres et al., 2017), we do not sample at the level of single notes but on the level of rhythmic and melodic motifs. For the generated scores to exhibit the fundamental repetition property of music, the set of possible motifs is derived from the music material of other voices. To induce repetitions within a voice, the StructureNet system (Medeot et al., 2018) introduced a related strategy. Third, BeethovANN is able to generate music for potentially very long pieces. We achieve this by considering a music piece as a sequence of independent musical phrases.

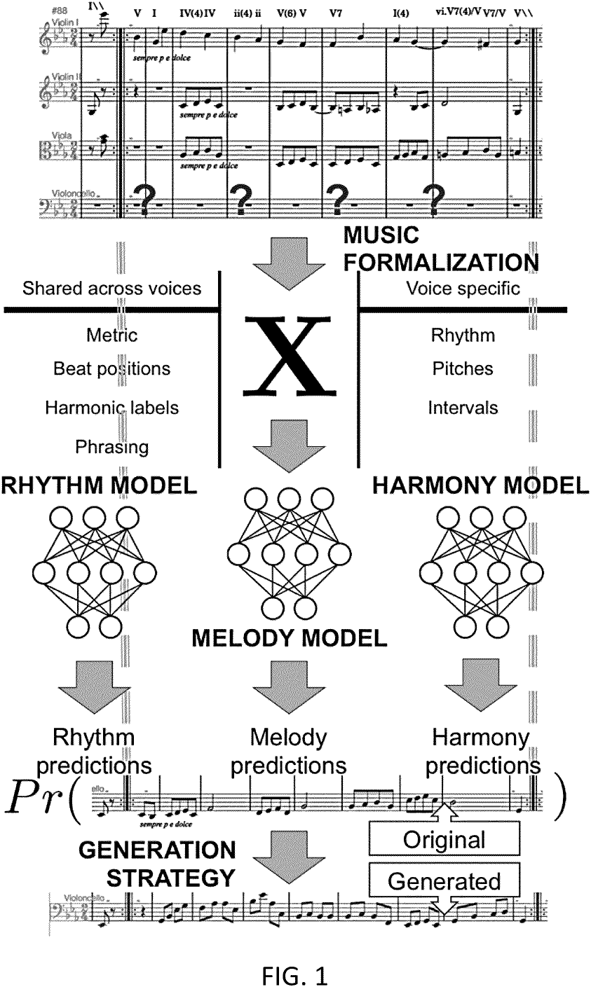

BeethovANN is an algorithm that processes the information in digital scores (i.e., Beethoven string quartets) to compose new musical lines, see for example in FIG. 1. It contains three essential components, viz. an efficient encoding of symbolic music into features; three neural networks for rhythm, melody, and harmony prediction, respectively; and a voice generation module, which we will discuss in turn. The code of BeethovANN was developed in the Python programming language, using the Tensorflow (Abadi et al., 2016) and Keras (Chollet, 2015) symbolic computing libraries to design, train, and evaluate the artificial neural networks.

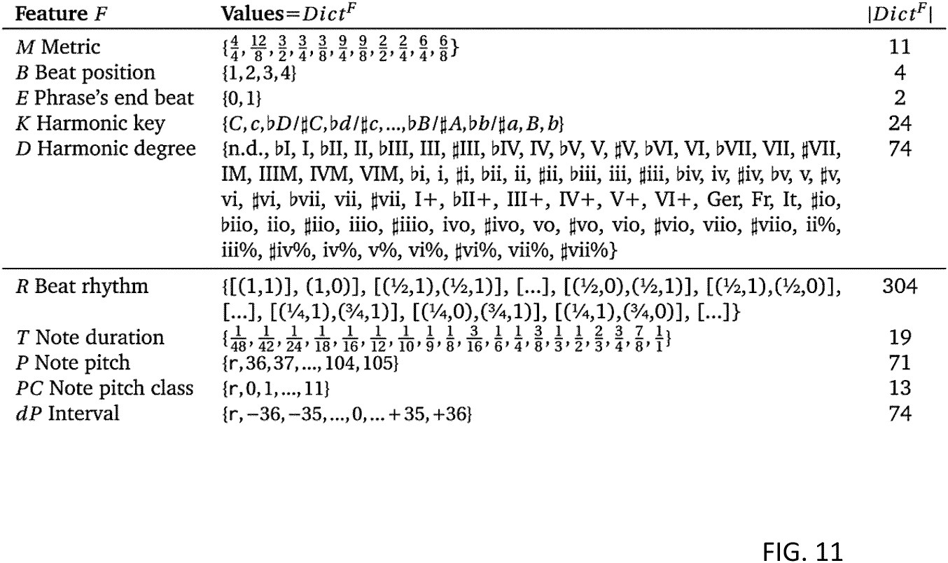

With respect to the representation of symbolic features for all pieces in the annotated Beethoven string quartets, we parse the corresponding MusicXML file to extract several features that describe the placement and context of each note in each voice. Five of these features are shared between all four voices. Moreover, each voice is characterized by five voice-specific features, see the table in FIG. 11 showing the list of features.

For each feature F ∈ {M, B, E, K, D, R, T, P, PC, d P }, we refer to the set of possible values (sometimes called feature dictionary) as Dict F . The norm operator |Dict F | symbolizes the size of this set. If the beat duration is one quarter note, the values for beat rhythm can be read as follows: quarter note = [(1,1)], quarter rest = [(1, 0)] two eight notes = [(½, 1), (½, 1)], etc., i.e. the second entry indicates whether the note is played or not. The values of pitch and pitch class are linked to the MIDI representation: {rest=r; C2=36; bD2/#C2=37; ...; A7=105} and {C=0; bD/#C=1; ... ; B=11}. Note that intervals dP are measured not only inside one voice (e.g., dP₁ for intervals within the melody of the first violin), but also with respect to other voices (e.g., dP₁|4 for the interval of the first violin between two consecutive cello notes).

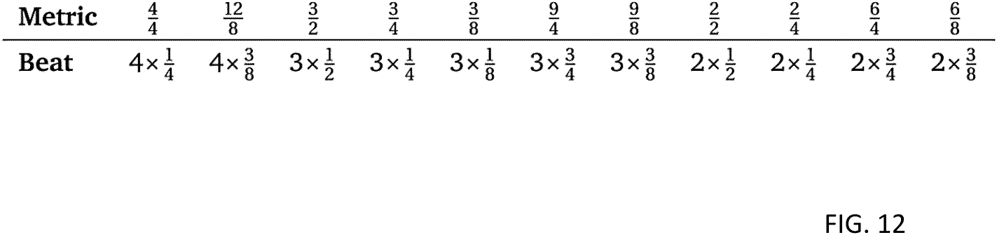

With respect to features that are shared across voices, the metric M dictates the beat (i.e., pulse) positions and lengths within measures (see the table of FIG. 12 for the exact mapping). For each metric, the corresponding number of beats and their length.). B indicates the beat position within bars, i.e., first, second, third, or fourth beat. E indicates whether the phrase ends at this beat (E=1) or not. K and D characterize the harmony of the beat. For the Beethoven string quartets, E, K, D are availablethrough the annotation of Neuwirth et al. (Neuwirthet al., 2018), but harmony labels have been reduced to seventy-four (74) possible labels.

With respect to voice-specific features, R encodes the normalized note onsets and durations within beats, i.e., the beat rhythm pattern, which can take one of 304 different values. Each value is a tuple (T, n) where T is the duration, expressed in fractions of the beat length, and n in{1, 0} indicates whether a note is played (n=1) or the duration is taken by a rest (n= 0). When more than one note are played in a beat, the representation is an ordered sequence of such tuples. For example, the [(1/1, 1), (⅓, 1), (⅓,1)] tuple encodes an eighth note triplet in 4/4 or three eighth notes in 6/8.

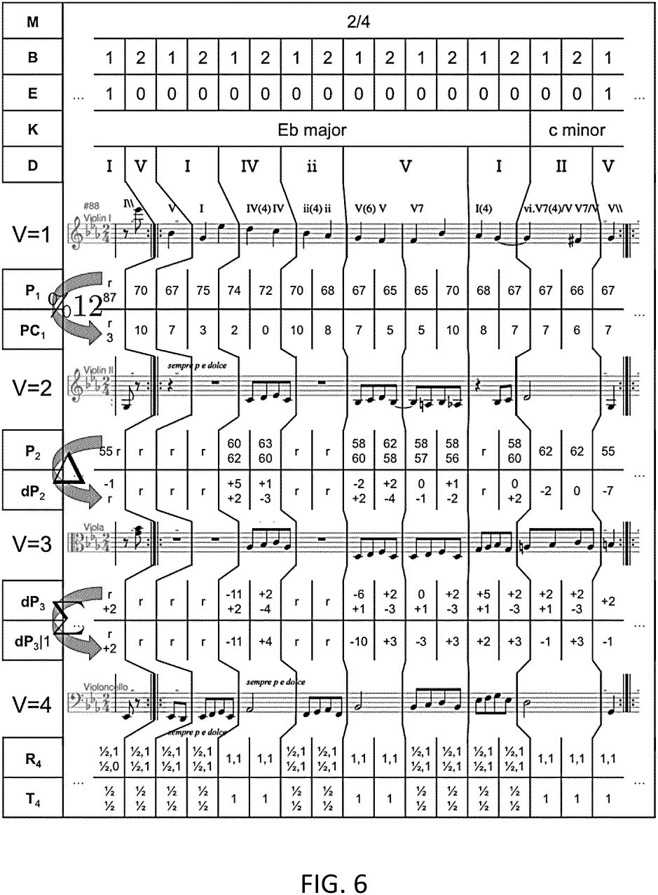

Every single note is directly represented by two features, i.e., its duration T and its pitch P. Furthermore, the pitch class feature PC represents the name of a note without its octave number (twelve-tone representation). The interval feature dP is the leap size (in halftones) from one note to the next. P, PC, and dP features can also take the value ‘r’ (an example of encoding is shown in FIG. 6) to encode rests in the music.

Because more than one note can be played on the other instruments between two notes of a single voice, the dP, P and PC features are adapted to the note sequence of every single instrument, e.g., the effectiveinterval of the viola in-between two notes of the first violin integrates all intervals performed by the viola within these two violin notes (e.g., dP₃|1 in FIG. 6 is the interval signal of the viola from the first violin perspective). Altogether, the four voices of a string quartet give rise to 44 voice-specific signals.

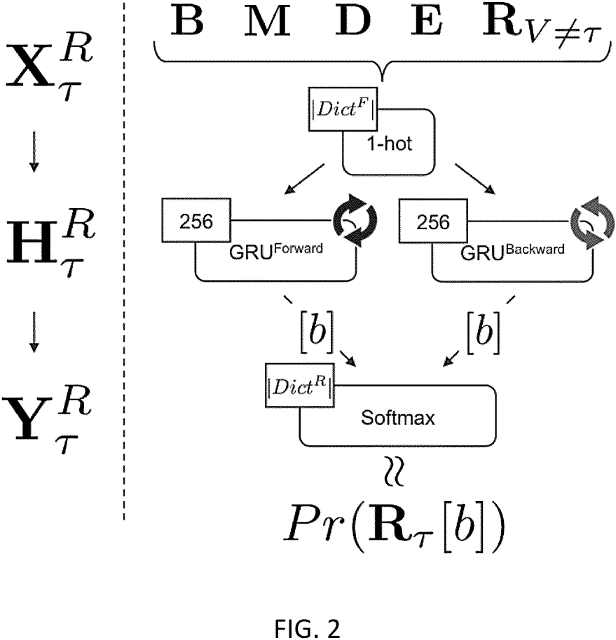

With respect to recurrent networks for rhythm and melody, the task of the four rhythm networks, one for eachvoice, is to accurately predict, for each beat of a musical phrase, the probability of occurrence of one of the 304 beat rhythms (see FIG. 2). FIG. 2 illustrates a rhythm model architecture. The rhythm network of a target voice τ consists of two fully connected networks of 256 Gated Recurrent Units (GRU) (Cho et al., 2014). The inputs to the rhythm network are the rhythm of other voices R_{v∉τ,} the beat position B, the metric M, and the phrasing E. Each of these input signals uses 1-hot encoding of every token with as many dimensions as the number of values the corresponding feature can take. The resulting 1-hot vectors are concatenated to represent the input of a single beat. One of the two recurrent layers starts at the beginning of the phrase and works forward in time while the other starts at the end and works backward. The layer dimensions are indicated in the upper left box. For every beat b in the context phrase, the network hidden state H^{R}[b] is read out with a softmax output layer Y^{R}[b]. It is the network approximation of the probability distribution over possible rhythm patterns for beat b. The architecture is the same for all four voices; yet training four different networks enables us to take into account that, e.g., the cello line typically exhibits slower rhythms than that of the first violin, and this difference will manifest itselfin independent network parameters. In the training phase, we update the network parameters to minimize the cross-entropy loss between the output probability distributions Y^{R} over beat rhythmical patterns (Dict^{R}) and the target voice sequences of such rhythms R_{τ}. We observe the convergence of the loss function on both training (90%) and validation (10% of the shuffled phrases) sets after 30 optimization epochs. Early stopping and a 0.1 dropout probability between all hidden layers prevent overfitting.

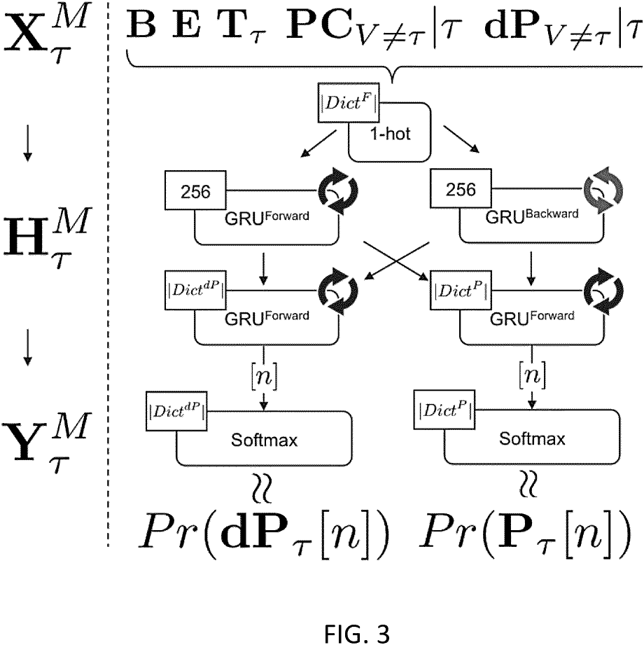

Similarly, the model of melody for a target voice τ (FIG. 3) is trained to predict the interval and pitch sequences of the target voice from the context defined by the melodic, metric, and harmonic features of other voices. For each data point consisting of the four voices during one phrase, our melody model processes the interval movements dP_{v∉τ}|τ and pitch classes PC_{V∉τ}|τ of other voices, the sequence of not duration T_{T} from the target voice (as generated by the rhythm network for final application; or as given by the original data during training) the phrasing E, and the positions inside a bar B, which are used as inputs (in 1-hot encoding format) to the recurrent network shown in FIG. 3. Note that each step in the melody network dynamics n is one note (in contrast to the rhythm model where one step is one beat). The approximated probability distributions for each note pitch P_{τ}[n] and interval dP_{T}[n] of target voice τ are read out from softmax units at the output layer. To augment the dataset and normalize the number of data points in each key, every phrase is transposed in every key. To reach the convergence of the categorical cross-entropy loss function, around eight (8) hours on a computer laptop (2.6 GHz CPU) are required to train the melody network for a single target voice. Note that each step in the melody network dynamics n is one note (in contrast to the rhythm model where one step is one beat). The approximated probability distributions for each note pitch P_{τ}[n] and interval dP_{τ}[n] of target voice τ are read out from softmax units at the output layer. To augment the dataset and normalize the number of data points in each key, every phrase is transposed in every key. To reach the convergence of the categorical cross-entropy loss function, around eight hours on a computer laptop (2.6 GHz CPU) are required to train the melody network for a single target voice.

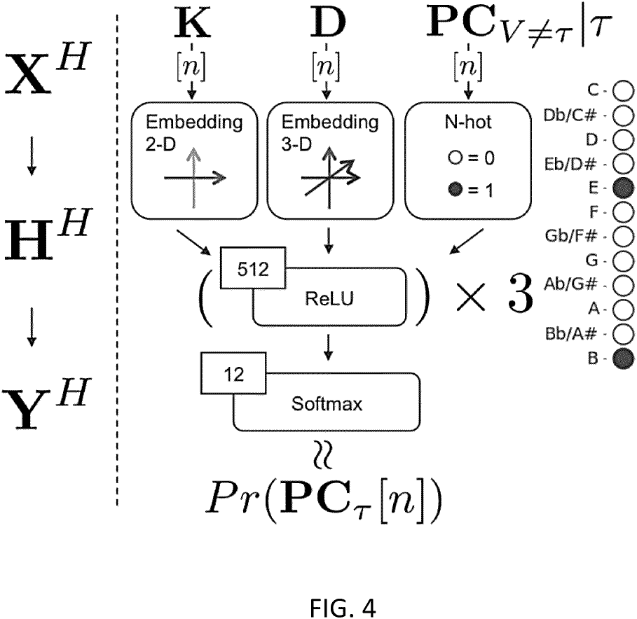

With respect to feedforward network for harmony, to collect the data needed to train the network model of harmony illustrated in FIG. 4, we extract for each voice and phrases pitch classes that are played together. To collect the data needed to train the network model of harmony illustrated in FIG. 4, we extract for each voice and phrases pitch classes that are played together

$${∪}_{V = 1}^{4} \left({\text{PC}}_{V} \left|\dot{\text{τ}}\right| n\right]$$

. Besides, the feedforward harmony network processes the harmonic labels K[n] and D[n] associated with this set of simultaneous pitch classes. Contrary to the rhythm and melody models, here we train a single network of harmony to predict the pitch class of any target voice from the notes of other voices and har-monic labels. After 20 training epochs taking around one hour of computing time on a 2.6 GHz CPU, the categorical cross-entropy loss between the network predictions and both validation (10% of the shuffled data)and training sets saturates, and training is stopped.

Returning to FIG. 4, this includes a harmony model architecture. The key (K) and the chord degree (D) are represented usingtrainable vector embeddings of dimensions 2 and 3 respectively, constrained to unit norm. The input pitch classes (PCs_{v∉τ}) are encoded by activating the corresponding units (here E and B). Also, we apply dropout with 0.1 probability for each layerof rectified linear units (ReLU). This network architecture is trained to predict left-out pitch classes from simultaneous notes and harmonic labels.

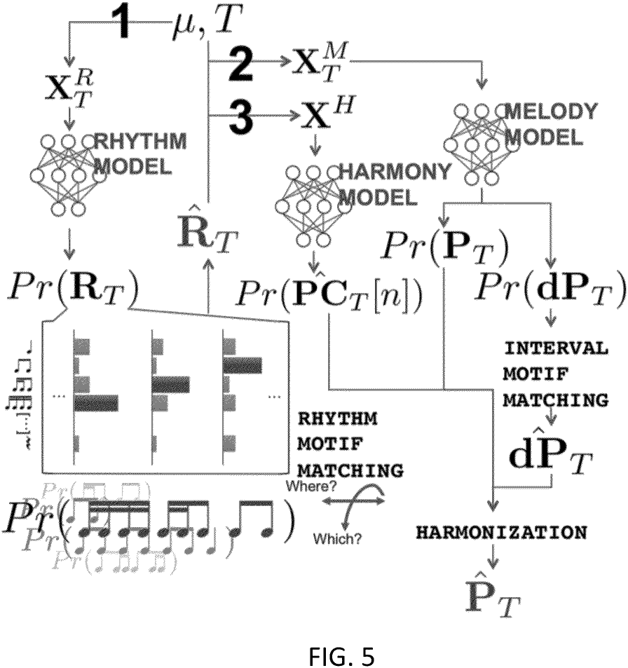

With respect to the voice generation module, for example, suppose that we want to generate for a specific phrase µ a new voice for the viola (target voice τ = 3). The generation occurs in three steps (i) to (iii) as discussed below and as shown in FIG. 5:
(i) We run the trained rhythm network for voice τ. For each beat of the phrase µ, the output of the rhythm network presents the probability of each of the 304 different beat rhythms. Starting with the first beat, we iteratively generate the rhythm, one motif at a time. To select the next motif, we group the beat motifs into rhythms spanning one, two, three, or four bars. There are, for example, 304⁴ different four-bar rhythms. On the other hand, we have access to the rhythmic groups of the same lengths that appear in the conditioning voices. Therefore, we estimate a probability for each of the four-bar rhythms by averaging the output probabilities associated to every motif over those four bars, and repeat the same for three-bar, two-bar, and single-bar groups. This rhythm motif matching procedure is illustrated in FIG. 5. If one, or several, of the rhythmic groups in the conditioning score have an estimated probability larger than 0.5, we copy the most likely rhythm motif. Else, we take the most likely rhythm generated by the rhythm model for a single beat. The process is repeated for the full phrase.
(ii) Once we have generated a rhythm signal for the target voice, the melody phase is initiated. To do so we run the melody prediction network for the target voice τ to generate, for each note, an interval signal (dP^τ). To select each interval, we also run a motif matching algorithm, this time working with interval motifs of 1 to 16 consecutive notes. The resulting intervals are taken as a proposition that is, if necessary, modified in the third step by the harmony model.
(iii) The predicted interval signal is adapted so that its final version P^τ fits the harmony progression of µ given by K and D, as well as all simultaneous notes in other voices given by PCs_{v∉τ}|τ. To do so, for each note, we select the pitch that is the closest to the predicted interval, has maximal pitch probability and a respective pitch class with a harmony model probability higher than 0.1. In addition, we prevent all generated voices to select any pitch class that is half a tone away from all simultaneous notes. Also, we prevent the repetition of consecutive notes when the predicted interval signal suggests otherwise (the predicted interval is different than 0). The interval generation and modification is repeated for all notes in the phrase.
After finishing steps (i) to (iii) we have the generated target voice over the whole duration of phrase µ.

FIG. 5 contains an illustration of a generation strategy. We generate a new rhythm and melody from a musical phrase µ anda target voice τ. This illustration of the generation strategy shows the pipelines through which different musical signals pass to generate one new ac- companying voice. In particular, we illustrate the motif matching algorithm. It consists in probing the output probabilities to find for a finite set of rhythm or interval motifs where, and which, has a maximal average probability.

Next, the results are described. A major contribution of our method is the encoding of symbolic music in multiple signals. We therefore start with an example of a phrase from Beethoven’s string quartets and show how it is encoded as a sequence of values from our 10 features. We then show how the trained model of harmony ‘rediscovers’ the music theoretical structure of the circle of fifths and show how the repetitive structure of motifs is represented with our model. Finally, we present music composed with BeethovANN.

Representation by forty-nine (49) signals. FIG. 6 illustrates an example of features during one phrase. From top to bottom: metric M; beat position B; phrase boundaries E; harmonic key K; harmonic degree and mode D; pitches Pᵥ for voice V {1, 2}; pitch class PCᵥ for voice V=1; interval dPᵥ for voice V=3 and as seen from the τ=1 perspective dP_{V}|τ; rhythm Rᵥ and note durations Tᵥ for voice V=4. The curved arrows illustrate the mathematical operations we applied to compute the respective features.

According to the phrase annotation by Neuwirth et al, Beethovens string quartets contain 821 musical phrases across 70 movements (Neuwirth et al., 2018). On average, a phrase contains 51 beats. The longest phrase has 490 beats. FIG. 6 takes one phrase to illustrate our translation from a music score to a sequence of features (not all voice-specific signals are shown).

The upper five features are shared for all voices (seeMethod Section) whereas the pitch P, pitch class PC, and note duration T signals (when feature F is typeset in bold (F), it refers to the ordered sequence of realizations from the F variable in a musical phrase) are voice-specific and indexed with the corresponding voice.

We take the example of the first violin (V=1), to show the signal encoding the note pitches P₁ It is determined by the unique MIDI integer associated with each pitch. The pitch class PC₁displayed below is obtained with the ‘modulo % 12’ operator.

We take second violin and viola as examples to show how the interval signal is constructed. dP₂ is computed as the difference of two subsequent notesof the voice of the second violin. Because any voicecan play more or less notes between two notes of a single voice, the notation dP₃|1 represents the total interval between the notes of the viola given those of the first voice. This signal is computed by integrating the intervals made by the third voice in-between two consecutive notes of the first voice. Finally, we use the cello to show the rhythm representation. Whereas T₄ considers only the duration of each note, R₄ also encodes whether notes are playedor not.

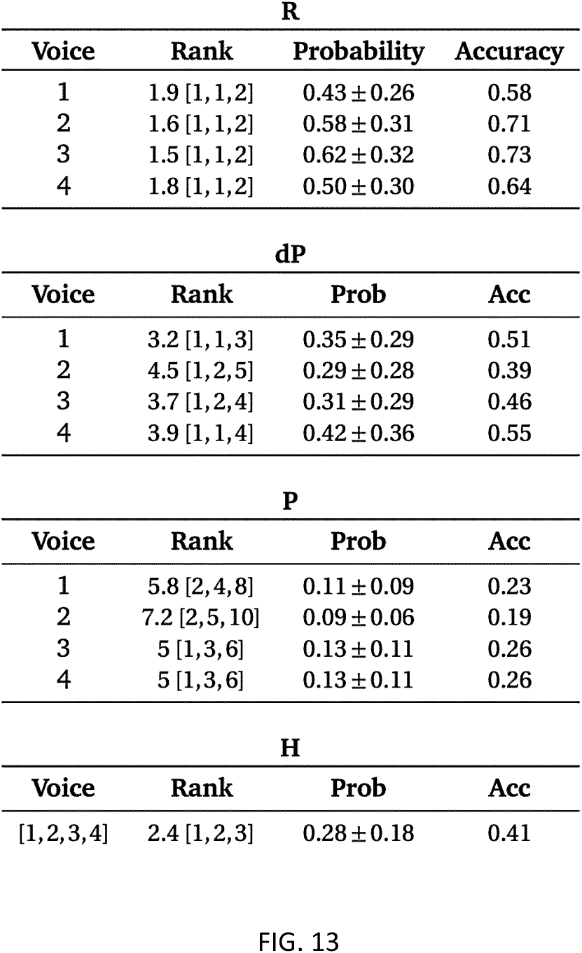

With respect to the performance of network models, the rhythm model has 304 output units with softmax characteristics so that we can interpret the value ofthe output j as the probability of the rhythm pattern with index j in the dictionary. To assess the trained rhythm models’ predictive performances, we compute the rank, probability, and accuracy, of the rhythm predictions for every beat of each voice in the Beethoven string quartets. The rank defines the place of the target rhythm (identical to Beethoven’s score) in the sorted network output probabilities. Thus, if the correct beat has index 17, and the output value of j= 17 is the largest output value it has rank 1, if it is the second largest it has rank 2, etc. The table of FIG. 13 reveals that for at least 50% of beats the correct rhythm has rank one, and for at least 75% of all beats, the correct rhythm is either rank 1 or rank 2. Furthermore, we provide the average probability that the rhythm networks allocate to the target rhythm.

FIG. 13 shows a table that contains values pertaining to performance of network models. These are summary statistics for the rank, computed probability, and accuracy of the network models’ predictions of Beethoven string quartets. The prediction rank is the rank of the target value in the sorted output probabilities. Here, we show the mean rank followed by the 0.25, 0.5, and 0.75 quantiles in brackets. The probability of the prediction is the output probability that the networks associate to the target value. We display the average probability standard deviation. The accuracy indicates the percentage of beats with a rank 1 prediction (0-1 loss). Note that for every beat, there are Dict^{R}=304 theoretically possible rhythms. For every note event, there are Dict^{P} =70 and Dict^{dP} =74 possible pitches, respectively intervals. For every harmonic prediction, there are Dict^{PC} =12 possible pitch classes. These values were obtained after retraining the network models with the entire Beethoven string quartets.

We evaluate the melody model’s predictive performances analogously. For all melody networks the correct interval is more than 50% of the time in the top two (2) candidates and accuracy is in the range between 39% and 51%. Moreover, the target pitch lies 50% of the time in the top five (5) candidates. Although the pitch predictions are useful for deciding on which octave the melodic lines evolve, they are of lower importance when combined with our voice generation module, which mainly relies on interval and harmonic predictions. Overall, these results indicate that pitch and rhythm networks make non-trivial predictions. Note that baseline chance probabilities would be at 1/304 for the rhythm and 1/74 for the interval predictiontask.

Finally, we evaluate the harmony model by computing the ranks and probabilities of the target pitch class in the ordered predictions. We observe that 25% of predictions exhibit the target pitch class in the first position, 50% in the first two most likely pitch classes, and 75% within the first three. More importantly, assuming we discard all pitch classes with output probabilities lower than 0.1; then 82% of all predictions havetheir target pitch class in the retained pitch classes.

With respect to the harmony model analysis, in the context of our overall goal of generating voices of a string quartet, we have to identify our model of harmony’s desired characteristics. The model’s primary goal is to filter the notes proposed by the melody model to choose the ones that complete target harmonies. How it solves this problem should reflect some common knowledge from music theory. However, in the case of an unsupervised learning model, music-theoretical concepts should be the result of training the harmony model instead of having them as input or hard-coded assumptions. To support the appropriateness of our model of harmony, we argue that it developed valid representations of some basic musical features.

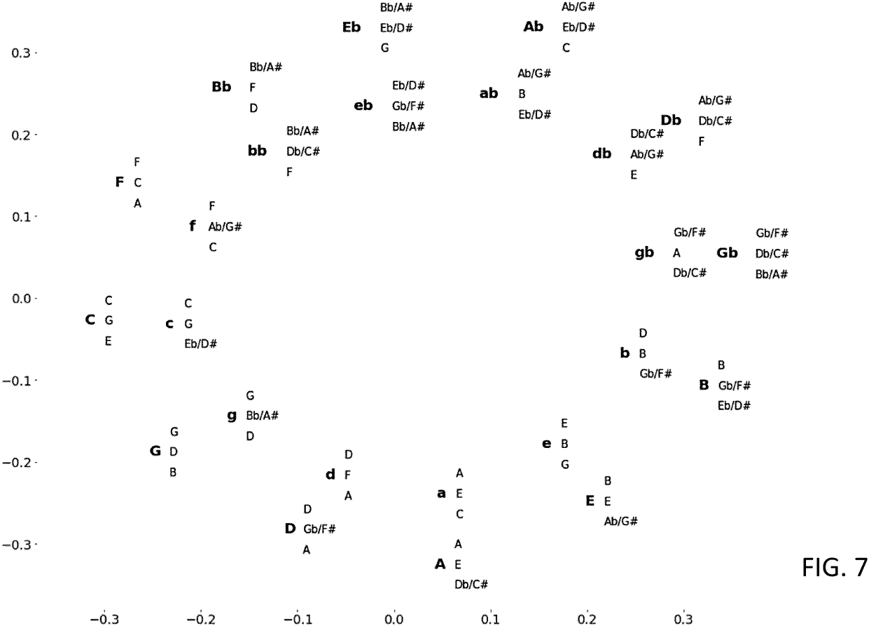

FIG. 7 includes an illustration of key embeddings: Visualization of the 2-dimensional key embedding representations after training. The projection found by the algorithm is similar to the theoretical circle of fifths. The three pitch classes displayed on the right of each key are the most likely pitch classes (ordered from top to bottom) according to the trained harmony model with inputs D[n] = I for major keys, D[n] = i for minor keys, and no simultaneous notes played by the other voices PCs_{v∉τ}|τ[n] = ø.

In FIG. 7, we visualize the harmony network representation of keys at its | embedding layer. In Mozer’s CONCERT system (Mozer, 1994), pitches are explicitly represented on the theoretical circle of fifths (Jensen, 1992). Interestingly, here the circle of fifths results as an emerging feature of the trained harmony model, which reflects musical and cognitive proximities between keys (Gauldin, 1997). FIG. 7 shows that these proximities are represented in the harmony network representation of keys.

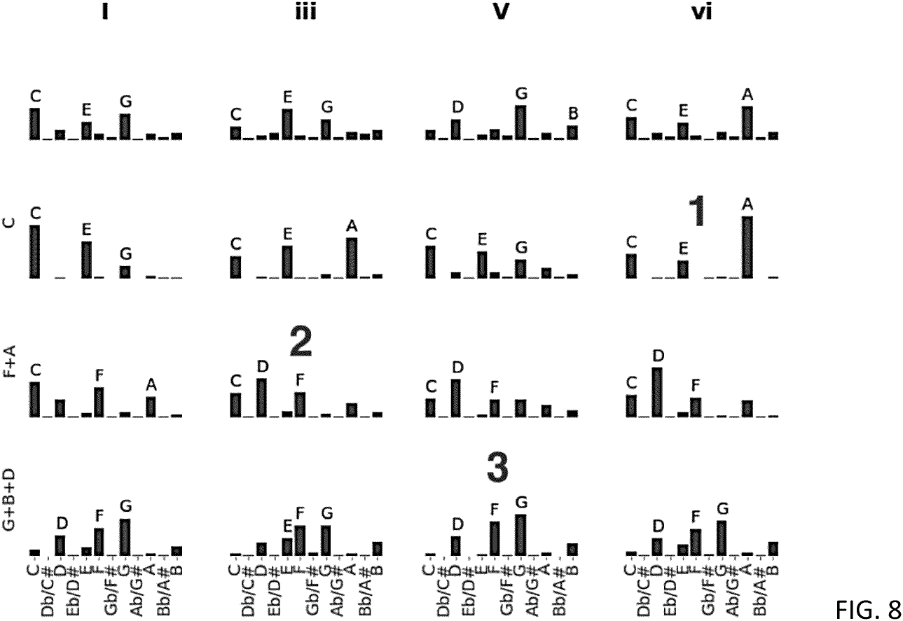

FIG. 8 includes an illustration of the effect of chord conditioning. Visualization of the output layer of the harmony network for different conditioning chord contents (rows) and harmonic labels (columns). The key is fixed to C Major. We added the label of notes when their probabilities are higher than 0.1. Numbered examples are explained in the main text.

Moreover, we analyzed the effect of conditioningthe predictions on the other pitch classes (PCs_{V∉τ}|τ[n] present in the chord. FIG. 8 shows that adding particular notes in the input chord adapts the output probability distribution over pitch classes to match the target harmony. This reflects the distribution of pitch classes that Beethoven selected for a target voice given the simultaneous notes in other voices in specified harmonic contexts. The first line displays the output probabilities when no simultaneous notes are played by the other voices.

For a given key, the model favors its root triad (except for the third scale degree where C is more likely than B). When more context notes are provided as input to the harmony model, the entropy of the distribution decreases to prevent out-of-context notes. For example, when the input notes do not belong to the harmonic label, the distributions adapt to prevent dissonances while preserving as much as possible the target harmony. In particular, the typical minor triad (A/C/E) of the sixth scale degree (vi) is consolidated when another instrument plays a C (the corresponding distribution is highlighted in the square box labeled #1). However, the root (A) is now highly favored. When the degree label of the harmony is D[n] iii and the F+A pitch classes are presented at the network in-put, the distribution adapts to remove the root and dis-sonant E pitch class as a possibility (example #2). This suggested chord is not anymore the third scale degree (iii), rather the second (ii). This correction is based onthe pitch classes of other voices and Beethoven choices, which are formalized in our training data. Finally, example #3 shows how the harmony model suggests a dominant seventh chord when all three dominant triad notes are presented to the network input. Unless a dissonant pitch class is provided to the model, the roots and thirds are favored when they are not provided as part of the conditioning chord.

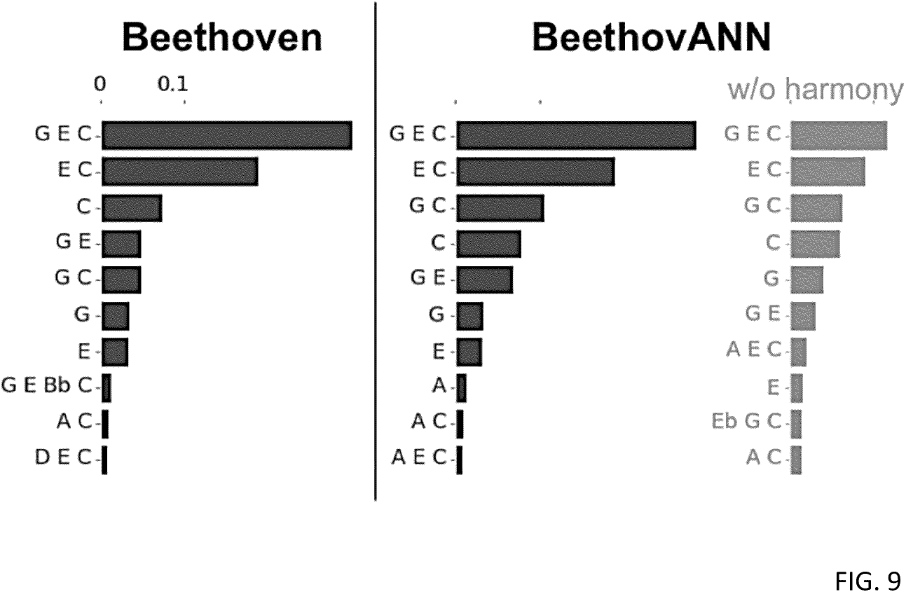

To show the relevance of the harmonic input during the generation of new voices, we lesioned the harmony model from our generation strategy and compared the results with those of the full model. We find that using the harmony model to correct the notes suggested by the interval motif matching algorithm allows BeethovANN to generate more harmonically correct simultaneous notes. In fact, the distribution of generated chords closely matches the original distribution of Beethoven scores (see FIG. 9).

FIG. 9 shows distribution of chords. The leftmost plot displays the distribution of the 10 most common major first degree chords in Beethoven string quartets. For all notes starting on the beat, we compute the frequency of each unique set of notes (transposed in C Major). In the middle, the same analysis applied to accompaniments generated with BeethovANN. The distribution of the ten (10) most frequent chords generated in BeethovANN’s accompaniments is similar to that of the original scores. On the rightmost plot, we lesioned the harmony model and the probability of the top two cords (GEC and EC) is reduced by about a factor of two indicating a drop in quality. In this case, the distributions do not match the original music. An example of generated scores without the harmony model can be found in the documentation of the BeethovANN algorithm.

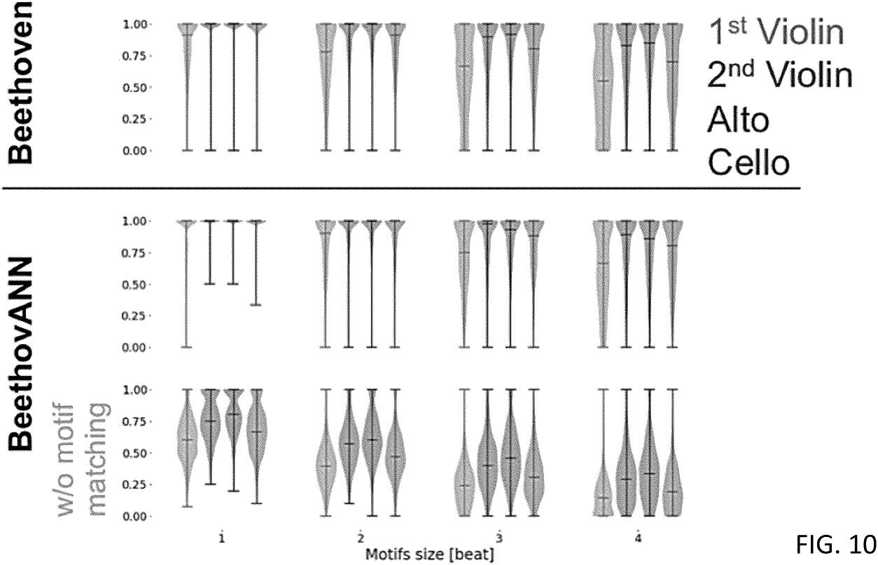

With respect to rhythm and melody motifs, FIG. 10 illustrates repetition of rhythm motifs. On top, distributions of the overlap of rhythm motifs (of motif sizes m in {1, 2, 3, 4} consecutive beats) across voices in the original string quartets of Beethoven. For a given voice V we identify a rhythmic motif and search if the same motif appears in one of the three other voices. In each of the four groups, the leftmost plot refers to the first violin, and the right-mot to the cello. The median (horizontal bar) can be read as follow: on average, withina phrase median percent of all m consecutive beats are repeated from the musical material of other voices. For example, for rhythm motifs overthree beats, the second violin and viola repeatmore than 90% of motifs of other voices (median) whereas the first violin only repeats 67% of motifs. In the middle, the same analysis applied to scores generated by our method basedon motif matching. The characteristic change between motifs of size one and size three and the differences between first violin and second violin are well captured by our method. On the bottom, generation of rhythm scores for all four voiceswith the rhythm model as explained in the paper, but after lesioning the motif-matching module. Rhythms are generated in each beat by choosing a rhythmic pattern according to its likelihood represented by the network model. In this case the characteristics of the original score of Beethoven are not reproduced.

In the context of the present invention, our formalization of symbolic music enables usto quantitatively analyze repetition patterns in Beethoven’s string quartets, as shown in FIG. 10. We notice that every voice has more than 50% of rhythm motifs (upto 4 beats long) repeating other voices. We also observe that the rhythm patterns of any single beat are nearly always repeated from other voices. Repetition is a property inherent to music (Temperley, 2014) that can be observed here with our formalization. However, to generate scores from probabilistic models exhibiting such repetitive structures is almost impossible with standard sampling techniques (Medeot et al., 2018). With these observations in mind, we designed our generation strategy such that the new accompanying melody contains rhythm and interval motifs from the input phrase.

If we lesion our generation module and directly sample the output of rhythm and melody networks,we find that the repetition of rhythmic motifs is further away from the original string quartets than with our generation module (see FIG. 10). Generation results can be also found in the documentation of the BeethovANN algorithm.

We can apply our generation strategy to generate new music scores from any music ensemble of up to four monophonic voices. For example, we processed the Beethoven’s string quartets to compose new ensembles. For the generation of the first violin, we removed the original first violin, but kept the other three voices. Similarly, for the generation of the second violin, we removed the second violin of the original score but kept the other three voices. Thus, the generated second violin can be seen as a potential replacement of Beethoven score for the second violin; but since it is not copying the original, it can also be seen as an addition to the four existing voices, turning the quartet into a quintet. Since this is true for each voice, the quartet has been augmented to an octet with consistent harmony. The fact that the generated voices are different from the originals confirms that our models do not overfit the training data. Therefore, we challenge BeeehovANN generalization by generating a new ensemble from the generated quartets as well. Interestingly, without processing any of the original voice-specific signals, they can also be played along with the generated quartets, suggesting that our harmony model fulfilled its role in selecting melodies that match the harmonic context. We also challenged BeethovANN to harmonize simple melodies that Beethoven did not compose. To do so, we initiate the score with the original melody associated to a voice, all other voices being silent. Then, we apply our generation strategy to add more voices to the generating score. Audio examples of the generated scores are displayed on the aforementioned media webpage.

In sum, with the herein presented system and method, we presented BeethovANN, an algorithm for automated music harmonization trained with the digital scores of the harmony annotated Beethoven string quartets (Neuwirth et al., 2018). It integrates three models employing artificial neural networks and a generation strategy that favors the repetition of musical ideas.

According to one aspect of the present invention, the augmentation of existing string quartets is made. To do so, we use scaffolding information at two levels. First, we generate one voiceat a time conditioned on the other three voices of Beethoven’s original score. For example, if we generate the alternative voice of the second violin, we condition on the first violin, viola and cello. If we then generate the alternative score of the viola, we condition on the original scores of first and second violin and cello. The second level of scaffolding is the harmonic sequence of the original Beethoven quartet that is always used as one of the inputs. Proceeding this way, we generate four additional voices that can be played in parallel to the existing voices (augmentation) or instead of the existing voices (generation in the style of a specific quartet). We can iterate this process. It is now possible to use the four alternative voices to condition the generation of yet another set of four voices. This final set is still in the style of the specific quartet, but none of the voices was conditioned on voices of the original quartet. Thus, the first level of scaffolding has been removed while the second level of scaffolding by the harmonic sequence remains.

Since we aim at augmentation or replacement of one specific string quartet, the question of overfittingis a delicate one. Paradoxically, the aim is to generate a score that resembles, say Opus 18 number 1, as opposed to generating a score that is generically like Beethoven’s early period. We note that the replacement of, say the second violin in Beethoven’s original score, produces a score that is different from the original, indicating that despite the superficial similarity it is not overfitting in the sense of mere copying.

A central contribution of our approach is that music generation does not happen tone by tone or beatby beat, but via the detour of a motif-matching algorithm. Our results indicate that the standard way of going beat by beat is not able to repeat the characteristics of repetition of rhythmic motifs found in Beethoven’s original scores, whereas our motif-matching approach achieves a high level of similarity in the quantitative measures, see FIG. 10. This indicates that an additional performance increase can be obtained by complementing neural-network approaches and related music generation strategies by a motif matching module.

Our methodology uses a formalization of music that operates on the rich encoding of digital scores in the MusicXML format with rich harmonic annotations (Neuwirth et al., 2018). Our harmony model is trained to infer which notes should be played together. Interestingly, during its training, the network representation of harmony labels evolved towards straightforward music-theoretic interpretations. In particular, we showed that it developed a hidden representation of musical keys matching the theoretical circle of fifths. A similar finding has been observed in the ChordRipple system for chord recommendation (Huang et al., 2016). There, the authors trained a neural network to predict chords and observed a distorted circle of fifthin the network embedding of input chords (each input unit represents a combination of chord key and form).

We believe that interesting future prospects include adapting the BeethovANN architecture to differentiate enharmonically equivalent notes with different names (Hadjeres et al., 2017). Also, BeethovANN was designed to handle sets of monophonic melodies interacting together. A challenging prospect could be to remodel the representations to enable BeethovANN to process scores featuring polyphonic voices (e.g., pieces including the piano). Also not addressed in this work is harmony generation. It should be an exciting challenge to build another model from which to generate the harmonic progression or consider hybrid generationwith approaches like generative grammars (Rohrmeier,2011). In our case, the harmony sequence progression was available through the annotation. However, independent of the source of a harmony model, the other components of our approach are transferable to other domains. For example, the music formalization can accommodate any digital scores representing ensembles of monophonic instruments.

With BeethovANN, we could augment the Beethoven string quartets for twelve separate voices. Therefore, enabling these renowned string quartets to be played by small orchestras with new unique voices. Eventually, such a technology can assist people in expressing their creativity and allow musicians to play scores originally not written for their particular formation. Finally, yet importantly, we believe that algorithms that create should never be considered as an alternative to human creation. Music composers typically want and can express personal emotionsor experiences in their work. The result of such a process should always be preferred over automated approaches. However, as a tool for creators, rather than a replacement, these algorithms can bring some art forms to broader audiences. In addition, they could also serve as innovative tools for trained composers or musicologists to create and analyze music. Of course, alternative variation of deep learning algorithms than BeethovANN may be used taking into consideration specific parameters for the type of composition being envisaged. In an example embodiment, a system and method is used to automatically generate scores for a symphonic orchestra in a single click.

For example, the BeethovANN symphony 10.1 is a music score that has been played live by the Nexus Orchestra (Geneva, 2-3.09.21) the very same day of its composition using the present automated music composition system. Different electronic publications have been made that show the performance and implementation of the herein described system and method, see for example https://www.thestar.com.my/tech/tech-news/2021/09/06/ai-helps-complete-beethoven039s-tenth-symphony, see also https://www.swissinfo.ch/eng/multimedia/from-beethoven--with-help-from-algorithms/46931566, and see the Youtube™ video link https://www.youtube.com/watch?v=907J99rVudM.

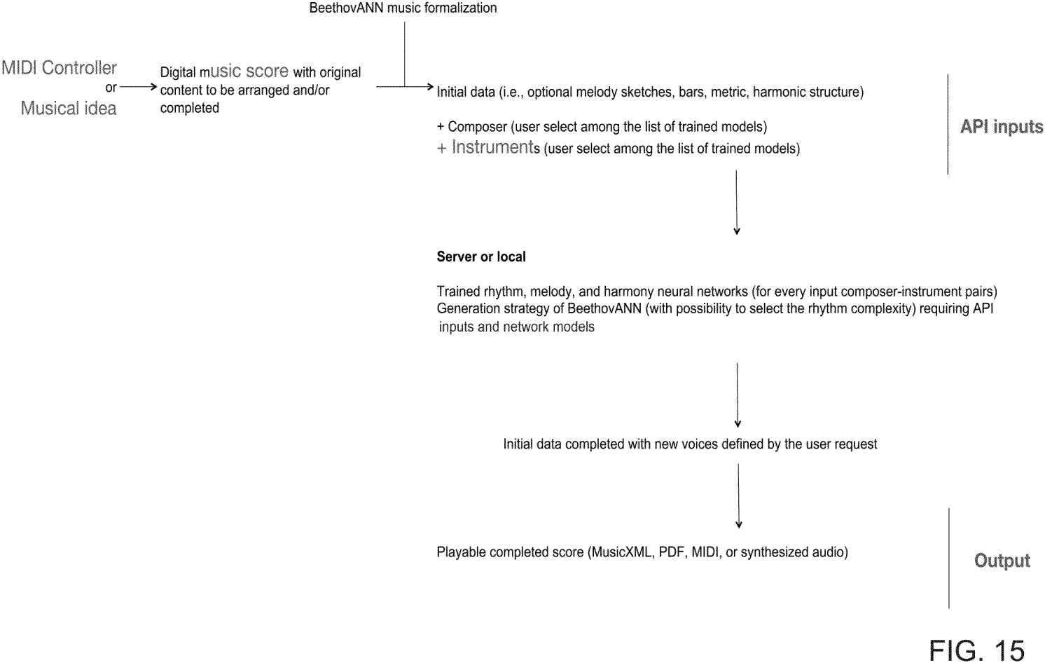

With reference to FIG. 15, which contains a flowchart, we selected a melodic phrase from Beethoven sketches of its 10^{th}symphony and processed it with the present invention to compose new voices for every instrument in the orchestra around this original Beethoven melody. However, the original music content is free of choice by the user. For example, we have also used this system to generate an orchestral score integrating the happy birthday melody inspired by Beethoven’s string quartet composition style.

In sum, the overall method approach can be described as follows. Write Beethoven’s sketch melody (or any user-specified score segment) in a digital score (with a user-specified number of bars) and harmonic labels (from original data, user-specified, or an automated approach to harmonic progression inference). To do so, we can use a MIDI keyboard controller or directly write in a music notation software (e.g. Musescore or Sibelius). This symbolic music is pre-processed using the BeethovANN formalization. The resulting data is processed through the BeethovANN algorithm to generate new voices that integrate the user-specified original melody. To communicate the data to the algorithm from web, app, or music software plug-ins clients can be done with network or local system calls through an API. The algorithm (parameters of the trained neural networks and program code) can be installed locally on a computer or stored on a server. Then, the API can send two types of requests:
1. Generate a score for user-specified instruments and composition styles (for example violin, viola, and cello from Beethoven’s string quartets) integrating the user-specified original music content;
2. Change parameters or parts of the generation strategy (for example the level of rhythm complexity, the pitch range, de/activate the motif-matching protocol); and
Next, the method can perform a communicating of the generated scores from the first request to the GUI (website, app, or music software plug-ins). As a non-exclusive alternative, the method can write the generated scores to a symbolic music file (e.g., MusicXML and MIDI). As another non-exclusive alternative, the method can write the generated scores to an audio music file (e.g., mp3) synthesized from the MIDI file.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. An automated music composition and generation system for automatically harmonizing digital pieces of music using an automated music composition and generation engine for multi-voice music harmonization, the system comprising:
a system-user interface configured to input user parameters comprising at least an instrument designation, a composer style designation, an empty or partial input musical score, whereby the instrument designation and the composer designation are any one of a predetermined list of instrument designations and composer designations;
an automated music composition and generation engine configured to implement a generation strategy, operationally connected to the system-user interface; and
a neural network module configured to implement a rhythm recurrent artificial neural network model, a melody recurrent artificial neural network model and a harmony feedforward neural network model that have been trained for combinations of the instrument designations and composer designations of the predetermined list,
wherein the automated music composition and generation engine further being operationally connected to the neural network module and configured to generate a newly composed musical score by operating the neural network module with the input user parameters, the newly composed musical score comprising a musical score for at least one instrument designation, and
wherein the system-user interface further being configured to receive the newly composed musical score from the automated music composition and generation engine, and output the newly composed musical score by means of the system-user interface.

2. The automated music composition and generation system of claim 1, wherein the music score is represented symbolically by a rich encoding scheme that includes rhythmic, melodic, as well as harmonic features.

3. The automated music composition and generation system of claim 1, wherein the music score is represented in a MusicXML format.

4. The automated music composition and generation system of claim 1, wherein the automated music composition and generation engine uses artificial neural networks based on the rhythm recurrent artificial neural network model, the melody recurrent artificial neural network model and the harmony feedforward neural network model to infer the newly composed musical score for at least one of a plurality of voices based on musical content of other voices comprised in the input musical score.

5. The automated music composition and generation system of claim 4, wherein the automated music composition and generation engine voices is configured to use an output of the rhythm and melody artificial network models to select amongst candidate motifs for rhythm and melody the one that is most likely to appear within the given musical phrase, and to use the harmony feedforward neural network model to adapt selected notes so as to match the given harmonic progression.

6. The automated music composition and generation system of claim 4, wherein
the rhythm artificial neural network is configured for each one of the multiple voices to predict for each beat of a musical phrase, a probability of occurrence on one of a predetermined set of beat rhythms.

7. The automated music composition and generation system of claim 4, wherein
the melody artificial neural network is configured for each one of the multiple voices to predict for a target voice in the output musical score the interval and pitch sequences of the target voice from a context defined by melodic, metric, and harmonic features of other voices.

8. The automated music composition and generation system of claim 4, wherein
the harmony feedforward neural network is configured to predict left-out pitch classes from simultaneous notes and harmonic labels.

9. A method for preprocessing of symbolic music comprising:
encoding rhythms, melody, and harmony of a least a training musical score comprising a plurality of voices, into 5 features shared across all of the plurality of voices plus 5 voice-specific features, the voice-specific features comprising for each voice not only the on-sets, durations, and pitches of notes within every beat, but also intervals within a voice and intervals to other voices, and
relying on meta-signals shared across voices such as the harmonic progression, beat position within the bar, and metric.

10. The method of preprocessing of claim 9, wherein the encoding of harmony comprises extracting for each voice and phrase pitch classes that are played together.
